(19) United States
(12) Patent Application Publication
(10) Pub. No.: US 2003/0122877 A1
(43) Pub. Date: Jul. 3, 2003

(54) Graphical user interface tools for specifying preferences in e-commerce applications

(75) Inventors: Shanmugasundaram Ravikumar, San Jose, CA (US); Dandapani Sivakumar, Cupertino, CA (US)

Correspondence Address: IBM Corporation, Almaden Research Center, 650 Harry Road, San Jose, CA, 95120-6099, US

(73) Assignee: International Business Machines Corporation

(21) Appl. No.: 10/035,999

(22) Filed: Dec. 31, 2001

(51) Int. Cl. G09G 5/00

(52) U.S. Cl. 345/811; 345/843; 345/825

(57) ABSTRACT

A system, method, and computer program product for customizing a graphical user interface in accordance with user rank-order preferences. A first embodiment presents a list of labeled items in either a vertical or horizontal orientation. A second, preferred embodiment includes a persistent pull-down list that presents items in a hierarchical form. In either embodiment, the user clicks and drags the items into a physical arrangement corresponding to the user's rank-order preferences of the items. The user can also dismiss items that are entirely unacceptable or completely uninteresting. A cut-off line can limit the number of presented items, so that limited display space is allocated only to relevant alternatives. The invention is of particular utility for electronic commerce applications.

### FIELD OF THE INVENTION

This invention relates to a system, method, and computer program product to enable a user to operate and customize a graphical user interface to easily and intuitively specify rank-order preferences, particularly in the context of electronic commerce. Specifically, the invention allows a user to rearrange, delete, and limit the number of items in a pull-down list so that the available items are physically positioned in accordance with the user's preferences.

### DESCRIPTION OF RELATED ART

Efficient gathering of information regarding personal preferences is an important task in many different fields. In the social sciences, surveys, polls, and questionnaires are widely used to measure personality traits, attitudes, and interests. Sometimes these tools are used to help determine which employment options would best fit the needs of a particular individual. Unfortunately, if there are many choices or alternatives to be considered, confusion can result, and the often-subjective information gathered may be muddled and misleading. In electronic commerce, clear communication between consumers and vendors is often of primary importance. Currently, several ad hoc mechanisms are used to gather information regarding user preferences. Unfortunately, these tend to be cumbersome and inconvenient. In one approach, the user is asked to enter a numerical score, say between 0 and 10, of the preference associated with each alternative. In a second approach, the user is simply asked to list a few acceptable (or unacceptable) alternatives. In yet another situation, the user is asked to enter a unique number (say 0 through 9) to represent the rank of each alternative in a list. None of these schemes are comprehensive and natural.

Others in the field have developed computer-based tools to help computer users communicate more effectively. A graphical user interface as generated by modern operating systems and commercial applications can help present information to a computer user in a clear manner. As the population becomes more computer-literate, graphical user interfaces and associated software tools or “widgets” are more routinely used for entering preference information and making choices. These choices often include specifying the preferred rank-order of a set of possible alternatives.

U.S. Pat. No. 4,908,758 to Sanders teaches a rank ordering system wherein a user specifies weighting factors for presented alternatives. The highest hierarchically ordered alternatives from each category are displayed, and the user selects one of the displayed alternatives as the highest ranked. The selection process repeats until all alternatives have been ranked. The user then distributes points between pairs of alternatives according to user-perceived relative importance.

Commonly-assigned U.S. Pat. No. 5,317,687 to Torres teaches the use of a graphical metaphor for a group of items in a video display, and direct manipulation techniques for rearrangement of the group and selection of particular items from the group. Icons depict an arrangement of items stacked on one another, selected items are moved to the top of the stack.

Commonly-assigned U.S. Pat. No. 5,781,193 to Alimpich et al. teaches the use of a graphical user interface to facilitate selection and generation of a subset list from a superset list.

U.S. Pat. No. 5,867,162 to O'Leary et al. teaches a method for enabling a user to edit picklists in a pull-down menu of a graphical user interface. Entries may be removed, and redundant entries may be filtered out. The least recently used items in the list may be removed by the user. The number of items in the list can be controlled by the user.

Commonly-assigned U.S. Pat. No. 6,208,340 to Amin et al. teaches a pull-down list with items having an associated control element (e.g. a radio button) for selecting items.

While the aforementioned prior art references are useful improvements in the field of customizable graphical user interfaces for information management, there still exists a need for an improved method for customizing a graphical user interface to easily and intuitively specify rank-order preferences for electronic commerce applications.

### SUMMARY OF THE INVENTION

It is accordingly an object of this invention to enable a user to operate and customize a graphical user interface to specify rank-order preferences.

It is a related object to allow the user to rearrange, delete, and limit the number of items in a pull-down menu or list of buttons so the available items in the list are physically positioned in accordance with the user's preferences. The items may be presented in a persistent, hierarchical pull-down menu, and can be clicked and dragged into a desired position. The items are preferably labeled so the user will easily understand which choices correspond to each item. The user can delete choices that are unacceptable or uninteresting, and can limit the number of available choices using a cut-off bar in the graphical user interface.

The invention can be used with any computing device, operating system, and commercial application capable of generating a graphical user interface. Any input device can be used to manipulate the items in the graphical user interface. The graphical user interface tools of the present invention can be readily programmed using HTML or JavaScript.

Once the user has customized the depiction of items in the graphical user interface according to the user's preferences, application software can then process the specified preferences. The criteria selected by the user and sorted into a particular arrangement indicative of user preferences can describe variables that define electronic commerce transactions.

The foregoing objects are believed to be satisfied by the embodiments of the present invention as described below.

### BRIEF DESCRIPTION OF THE DRAWINGS

FIG. 1 is a diagram of a list of buttons according to a first embodiment of the present invention.

FIG. 2 is a diagram of a persistent hierarchical pull-down menu according to a preferred embodiment of the present invention.

### DETAILED DESCRIPTION OF THE INVENTION

Consider, for example, a travel planning system, where a user wishes to travel between two cities on a particular date. There are numerous flight options offered by different airlines, and the travel planning system has to order them somehow and return the few best plans to the user. There are several criteria the user might employ to order the plans; the total price, the number of stops, aircraft type, available seating options (window/aisle), or time of day, for example. Within each criterion, the user might have a preference of the available options. For example, a user might prefer mornings most strongly, followed by red-eye flights, afternoons, and evenings, in that order. Also, a user might associate different degrees of importance to the criteria themselves. For example, a user might attach much more important to preferences about travel time than to the preference about seating. Similar scenarios arise when choosing a restaurant, or buying a car online, and many other online shopping experiences.

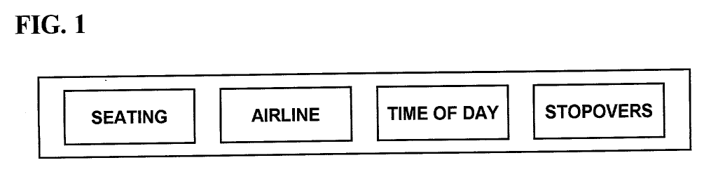

Referring now to FIG. 1, a diagram of a list of buttons according to a first embodiment of the present invention is shown. Each button is preferably labeled with a choice or choice category so the user will easily understand the correspondence between each button and the associated preference subject matter. In this example, the buttons are shown in a horizontal configuration, but a vertical configuration is also within the scope of the invention. The user can click and drag each button (by natural movements of a mouse, for example) into a different position within the list, according to the relative importance the user places on each choice or choice category. In the horizontal arrangement shown, with English labels, the leftmost category “Seating” is the primary criterion being considered by the user, and categories “Airline”, “Time of Day”, and “Stopovers” are other criteria of decreasing significance, in that order. In a vertical arrangement (not shown), the top button typically represents the criterion of primary significance, and the significance of other criteria or the desirability of other choices are indicated by their relative altitude, so the lowest button represents the criterion of lowest significance or the choice of least desirability. In other words, the user rearranges graphical user interface items into a physical arrangement corresponding to the user's rank-order preferences of the categories or choices represented by the items.

The user can also dismiss graphical user interface items that represent choices that are entirely unacceptable. Similarly, the user can dismiss items representing completely uninteresting choices or categories, so that only interesting ones remain to be specified. Typically, a user would use a right mouse-click to dismiss such items, alternately, a user can drag and drop such items into a “recycle bin” within the graphical user interface, as is known in the art. A cut-off bar (not shown) in the graphical user interface can also be positioned by the user, so that graphical interface items to the right of or below the cut-off bar for example are dismissed. The invention is designed to enable the user to rank-order a small set of alternatives or alternative categories. The ability to limit the number of items presented for consideration is important, as it prevents confusion and makes the best use of limited display real estate. Once the user has filtered and arranged a set of alternatives according to the user's preferences, upon user command the invention then processes the preference information as appropriate to the application. The first embodiment is most easily and naturally implemented through JavaScript, as would be readily apparent to one of ordinary skill in the art of graphical user interface design.

The invention can be embodied in a system including a computing device for generating the graphical user interface and an input device enabling the user to arrange items within the graphical user interface. The computing device may be a conventional personal computer, including laptop computers such as the ThinkPad (R) series available from IBM Corporation of Armonk, N.Y. Alternately, a personal digital assistant (PDA), a pager, or a cellular telephone can serve as the computing platform of the invention. The input device used in the invention can include a conventional mouse, a TrackPoint (R) device available from IBM Corporation of Armonk, N.Y., a trackball, a keyboard, a stylus, a touch-sensitive screen, and a speech analysis tool such as ViaVoice (R) available from IBM Corporation of Armonk, N.Y. Other computing devices and input devices are readily familiar to those of ordinary skill in the art and are also within the scope of the invention.

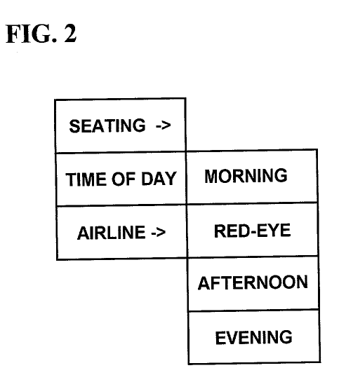

Referring now to FIG. 2, a diagram of a persistent hierarchical pull-down menu according to a second, preferred embodiment of the present invention is shown. At the highest level of the hierarchy, the pull-down list or menu includes labeled items representing categories or criteria, such as “Seating”, “Time of Day”, and “Airline” for example. When one of the items in a level of the hierarchy is selected, typically via a left mouse click, the invention displays a subsequent level of the hierarchy with a list of choices such as “Morning”, “Red-Eye”, “Afternoon”, and “Evening” in this example. As with the first embodiment, the user can click on an alternative and drag it across other alternatives to a correct position. Choices of equal preference may be placed side-by-side by the user. The invention then rearranges the labeled items accordingly. This embodiment also allows the user to delete or limit the number of items presented, as described above, until the physical arrangement of alternatives corresponds to the user's preferences. Since lists are already part of the HTML specification, this embodiment is most naturally implemented as an enhancement of HTML.

Although the invention has been described in terms of a travel reservation system, other electronic commerce applications are within the scope of the invention. Persons using the internet or other computer network may employ the invention to choose a restaurant based on location or cuisine. The invention is also useful for online shopping, which can include selecting particular products from particular vendors, and specifying shipping options. Job hunters can specify employment interests using the invention, and the preference data can then be uploaded to employment databases. Similarly, marketers may employ the invention to gather marketing data in place of or in addition to conventional questionnaires and surveys.

A general purpose computer is programmed according to the inventive steps herein. The invention can also be embodied as an article of manufacture—a machine component—that is used by a digital processing apparatus to execute the present logic. This invention is realized in a critical machine component that causes a digital processing apparatus to perform the inventive method steps herein. The invention may be embodied by a computer program that is executed by a processor within a computer as a series of computer-executable instructions. These instructions may reside, for example, in RAM of a computer or on a hard drive or optical drive of the computer, or the instructions may be stored on a DASD array, magnetic tape, electronic read-only memory, or other appropriate data storage device.

While the particular GRAPHICAL USER INTERFACE TOOLS FOR SPECIFYING PREFERENCES IN E-COMMERCE APPLICATIONS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for”.

We claim:

1. A method for specifying user preferences, comprising the steps of:
generating a pull-down menu in a graphical user interface; and
moving labeled items in said pull-down menu representing choices such that relative positions of said items correspond to relative user preferences.

2. The method of claim 1 comprising the further step of deleting said items representing unacceptable user choices.

3. The method of claim 1 comprising the further step of deleting said items representing uninteresting user choices.

4. The method of claim 1 comprising the further step of limiting the number of said items using a cut-off bar.

5. The method of claim 1 wherein said moving step comprises substeps of clicking and dragging.

6. A system for specifying user preferences, comprising:
a computing device generating a graphical user interface;
a pull-down menu in said graphical user interface including labeled items representing choices available to a user; and
an input device enabling said user to arrange said items such that relative positions of said items correspond to relative user preferences.

7. The system of claim 6 wherein said computing device is at least one of:
a personal computer, a cellular telephone, a personal digital assistant, a pager.

8. The system of claim 6 wherein said pull-down menu is persistent.

9. The system of claim 6 wherein said items form a hierarchy.

10. The system of claim 6 wherein said pull-down menu is a vertical list of buttons.

11. The system of claim 6 wherein said pull-down menu is a horizontal list of buttons.

12. The system of claim 6 wherein said pull-down menu is implemented in at least one of HTML, JavaScript.

13. The system of claim 6 wherein said choices describe variables defining electronic commerce transactions.

14. The system of claim 13 wherein said electronic commerce transactions include at least one of making travel reservations, shopping online, specifying shipping options, choosing a restaurant, selecting a vendor, providing marketing data, specifying employment interests.

15. The system of claim 6 wherein said input device is at least one of: a mouse, a TrackPoint(R) device, a trackball, a keyboard, a stylus, a touch-sensitive screen, a speech analyzer.

16. A system for specifying user preferences, comprising:
means for generating a pull-down menu in a graphical user interface; and
means for moving labeled items in said pull-down menu representing choices such that relative positions of said items correspond to relative user preferences.

17. A computer program product for specifying user preferences comprising a machine-readable medium having computer-executable code means thereon including:
a first code means for generating a pull-down menu in a graphical user interface;
a second code means for moving labeled items in said pull-down menu representing choices such that relative positions of said items correspond to relative user preferences; and
a third code means for processing said specified user preferences.
